(19) United States
(12) Patent Application Publication
(10) Pub. No.: US 2008/0078409 A1
(43) Pub. Date: Apr. 3, 2008

(54) Apparatus for leg abduction

(76) Inventor: Elizabeth Ann Ciccantelli, Albuquerque, NM (US)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 11/520,989

(22) Filed: Sep. 14, 2006

(51) Int. Cl. A61G 15/00

(52) U.S. Cl. 128/845

(57) ABSTRACT

An apparatus for abducting a debilitated patient's legs. In a preferred embodiment, an apparatus operates in a scissor-like manner to abduct a patient's legs. Two arms each support at least one cuff for holding a patient's legs. The arms pivot about a joint intermediate the ends of the arms. The cuffs preferably pivot about a ball joint. The apparatus may be locked in a variety of positions so that a medical practitioner may gain access to the patient's perineal area. In an alternative embodiment, the two arms are pivotally connected to a frame about their ends, and the arms are actuated by a worm gear thereby abducting a patient's legs.

### FIELD OF INVENTION

The present invention is generally related to medical devices. More particularly, the present invention is an apparatus for abducting a patient's legs to access the patient's perineal area.

### BACKGROUND

Patients suffering from various debilitative disorders require intensive medical care. A patient whose debilitation has progressed to where the patient is confined his or her bed requires constant medical attention. It is critically important for a bed confined patient to receive appropriate personal care, including general cleansing, catheterization, and various other medical procedures. However, it is often difficult for a medical practitioner to gain access to a debilitated patient's perineal area to provide care. It is especially difficult for a single practitioner to abduct a patient's legs to gain access to the perineal area. Furthermore, once the patient's legs are abducted, the patient may become restless and move slightly such that access becomes obstructed or is blocked altogether.

Accordingly, it is desirable to provide a lightweight, portable, easy-to-operate device that is comfortable for the patient and provides appropriate leg abduction.

### SUMMARY

The present invention is an apparatus for abducting a debilitated patient's legs. In a preferred embodiment, an apparatus operates in a scissor-like manner to abduct a patient's legs. Two arms each support at least one cuff for holding a patient's legs. The arms pivot about a joint intermediate the ends of the arms. The cuffs preferably pivot about a ball joint. The apparatus may be locked in a variety of positions so that a medical practitioner may gain access to the patient's perineal area. In an alternative embodiment, the two arms are pivotally connected to a frame about their ends, and the arms are actuated by a worm gear thereby abducting a patient's legs.

### BRIEF DESCRIPTION OF THE DRAWINGS

The preferred embodiments of the present invention will now be described in detail with reference to the drawings, wherein like numerals indicate like elements throughout, and

FIG. 1 is a front elevation view an apparatus for abducting a patient's legs in accordance with a preferred embodiment of the present invention;

FIG. 2 is a perspective view of the apparatus shown in FIG. 1 in a fully extended position;

FIG. 3 is a perspective view of the apparatus shown in FIG. 1 abducting a patient's legs;

FIG. 4 is a front elevation view of an apparatus for abducting a patient's legs in accordance with an alternative embodiment of the present invention;

FIG. 5 is a perspective view of the apparatus of FIG. 4; and

FIG. 6 is a close-up front view of the apparatus of FIG. 4.

### DETAILED DESCRIPTION OF THE PREFERRED EMBODIMENTS

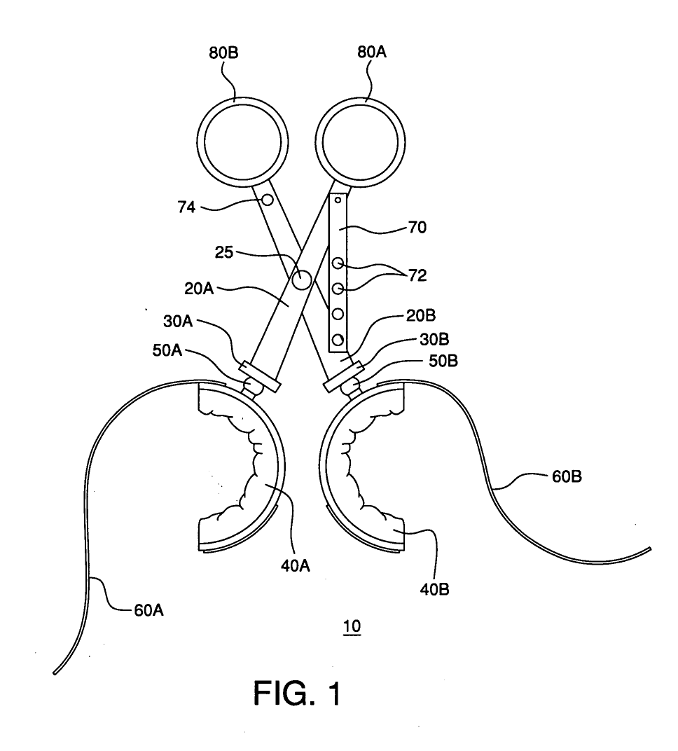

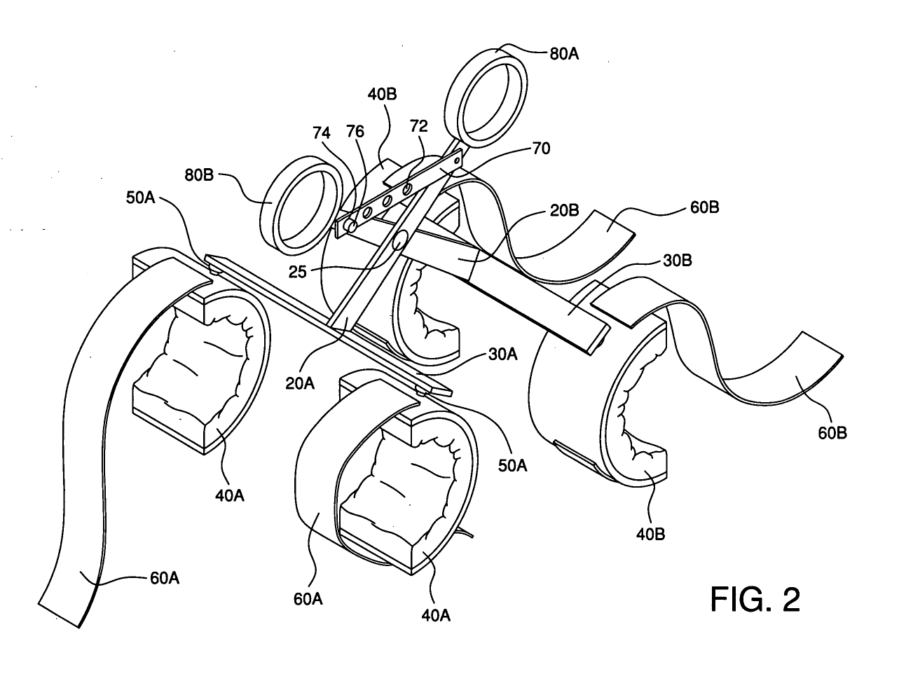

The following embodiment is a simple yet effective device that allows a single medical practitioner to easily access the perineal area of a patient having neurological damage or some other debilitative disorder. FIGS. 1 and 2 show an apparatus 10 for abducting a patient's legs. The apparatus 10 comprises two support arms 20A, 20B connected via a pivot joint 25. The pivot joint 25 allows the two support arms 20A, 20B to move in a scissor like motion. Cuff supports 30A, 30B are rigidly attached to the two support arms 20A, 20B, respectively, in a generally perpendicular orientation. Cuffs 40A, 40B are located at each end of the cuff supports 30A, 30B. This can be seen more clearly in FIG. 2. The cuffs 40A, 40B may be rigidly attached to the cuff supports 30A, 30B, respectively, or preferably the cuffs 40A, 40B are pivotally connected to the cuff supports 30A, 30B via joints 50A, 50B, respectively. Joints 50A, 50B allow the cuffs 40A, 40B to move slightly to more comfortably accommodate the patient's thighs and knees. Preferably, joints 50A, 50B are ball type joints that allow motion along all 3 axes.

Preferably, the cuffs 40A, 40B are generally “C” shaped, but may be alternative shapes as desired. Cuffs 40A, 40B may be sized as required to accommodate patients of various sizes. A soft, removable, washable material preferably covers the interior portion of the cuffs 40A, 40B for the patient's comfort. This material may be, purely by way of example, a synthetic foam material. Velcro straps 60A, 60B allow a medical practitioner to secure a patient's legs in the cuffs 40A, 40B.

A stabilizing bar 70 is pivotally attached to support arm 20A, preferably at the end opposite the cuff 40A. The stabilizing bar 70 may swing in generally a parallel plane as the pivoting action of the support arms 20A, 20B. The stabilizing bar 70 may include a plurality of apertures 72 through which a lock pin 76 may secure the stabilizing bar in position through an aperture 74 in the support arm 40B. The plurality of apertures 72 in the stabilizing bar 70 allows a medical practitioner to adjust the cuffs 40A, 40B and thereby abduct the patient's legs to a desired abduction and maintain the abduction. Alternatively, other locking means may be employed for securing the support arms 20A, 20B in an abducting position. For example, a thumb screw, a hook and clasp, or a lockable articulating rod may be used for stabilizing the apparatus 10 in an open position. It should be noted that FIG. 1 shows the apparatus 10 in a collapsed position, while FIG. 2 shows the apparatus 10 in a fully extended position.

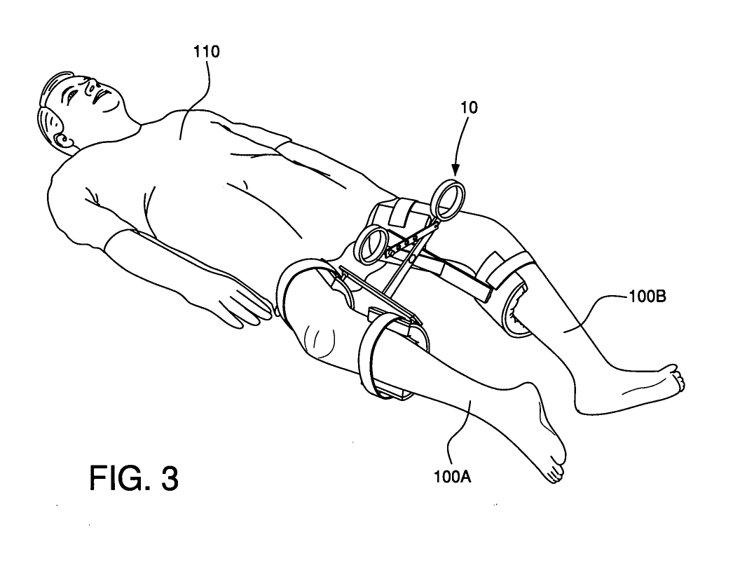

Referring to FIG. 3, the apparatus 10 is shown abducting the legs 100A, 100B of a patient 110. In a preferred embodiment, when in use the support arms 20A, 20B are substantially perpendicular to a plane formed by the patient's legs. In this embodiment, a medical practitioner may apply a generally downward force to grips 80A, 80B, thereby using the force of gravity to abduct the patient's legs.

The material of construction of the apparatus 10 is preferably a thermoplastic. Various thermoplastics may be utilized, with lightweight, easy to machine and manufacture plastics being most preferable. Additionally, preferably the exterior portions of the apparatus 10 are smooth for ease of cleaning. Alternatively, pivot joint 30 may be a ball joint that allows the support arms 20A, 20B to pivot about all 3 axes, thereby making abduction of a patient's legs more comfortable by allowing more leg positions. It should be noted that the apparatus 10 may be sized based on the size of the patient. The support arms 20A, 20B, cuff arms 30A, 30B, cuffs 40A, 40B, and various other components of the apparatus 10 may be adjusted based on the size of a patient. Several sizes may be required to accommodate large and small patients, including children.

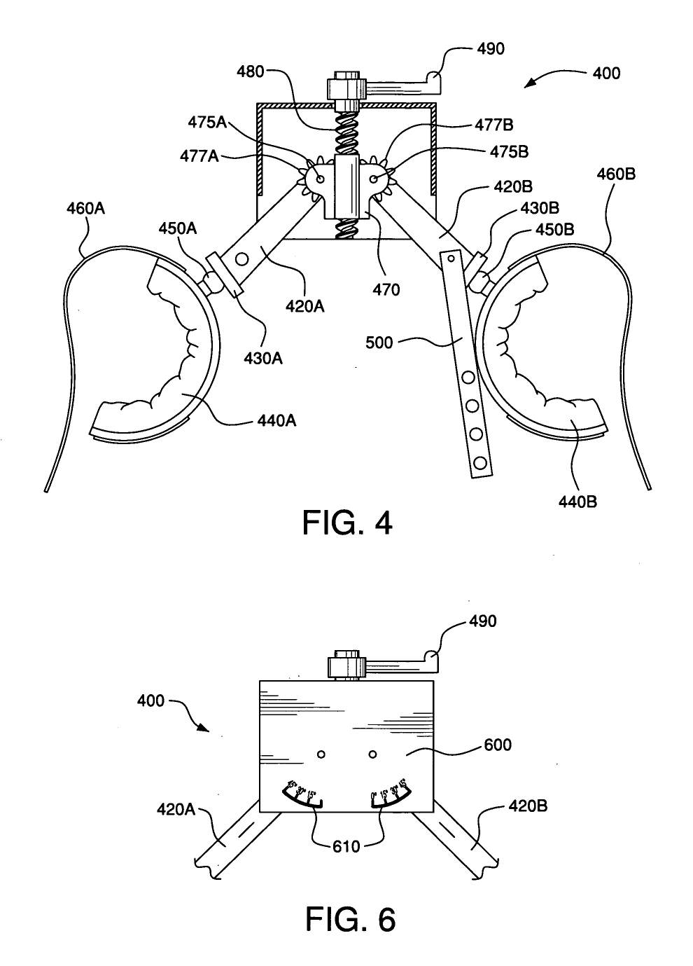

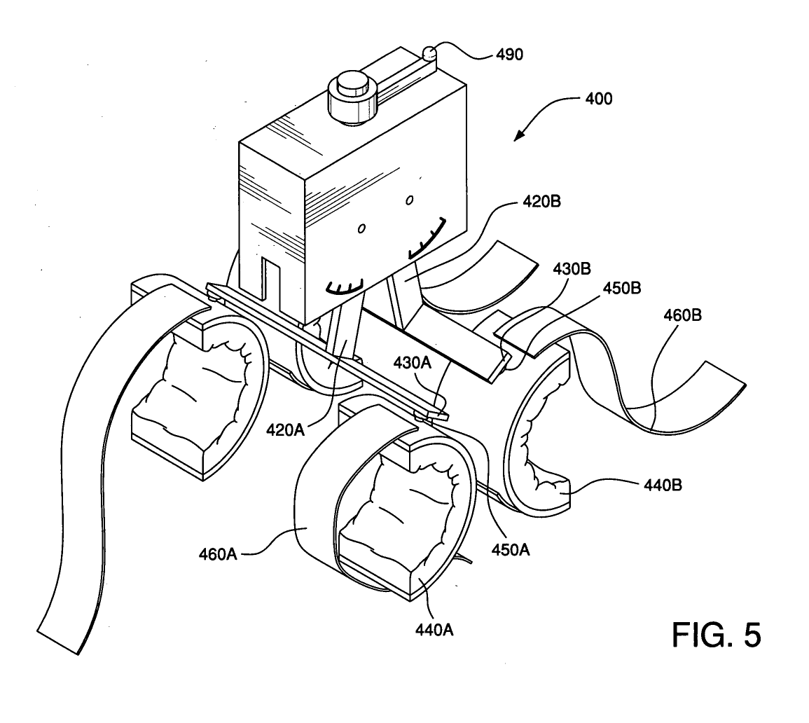

In an alternative embodiment of the present invention, referring to FIGS. 4 and 5, a device 400 for abducting a patient's legs is shown. The device 400 is similar to apparatus 10, however, its manner of operation is slightly different. The device 400 utilizes a worm gear design to abduct a patient's legs. The worm gear design is beneficial because the large frictional forces in a worm gear minimize the chance a patient may alter the degree of abduction. More particularly, support arms 420A, 420B attach to cuff supports 430A, 430B. Cuff supports 430A, 430B are rigidly attached to the two support arms 420A, 420B, respectively, in a generally perpendicular orientation. Cuffs 440A, 440B are pivotally attached to cuff supports 430A, 440B via joints 450A, 450B, respectively. Cuffs 440A, 440B preferably include Velcro straps 460A, 460B for securing a patient's legs. Support arms 420A, 420B pivotally attach to frame 470 by way of pivot joints 475A, 475B. A plurality of teeth 477A, 477B are integral to each support arm 420A, 420B, and engage with screw 480. Screw 480, when rotated, drives the teeth 477A, 477B thereby causing the support arms 420A, 420B to pivot about pivot joints 475A, 475B. A crank 490 allows a medical practitioner to drive the screw 480, thereby abducting a patient's legs. The length of the crank 490 may be adjustable, or may be sized appropriately to enable a medical practitioner to achieve the necessary torque to operate the device 400. Stabilizing bar 500 may be provided to lock the device 400 in an open position, in a similar manner as described above with reference to apparatus 10. Alternatively, a locking mechanism may be provided at the crank 490, taking advantage of the inherent properties of the worm gear. In a preferred embodiment, the arms 420A, 420B extend generally perpendicular to a plane formed by the patient's legs.

Referring to FIG. 6, a housing 600 is provided for protecting the interworking components of the device 400. Preferably, a scale 610 for indicating the amount of abduction, in degrees, is provided on the outside of the housing 600. Preferably, the device 400 is constructed from thermoplastic materials, providing a lightweight and easy to clean device for abducting a debilitated patient's legs. It should be noted that the device 400 may be sized based on the size of the patient, as discussed above.

What is claimed is:

1. An apparatus for abducting the legs of a patient, the apparatus comprising:
first and second support arms, each support arm having a first and second end;
first and second cuff supports, each cuff support having a first and second end, and each cuff support attached to the first end of the first and second support arms, respectively;
a plurality of cuffs, at least one cuff at said first and second ends of each of said first and second cuff supports, the cuffs adapted for securing the patient's legs,
a pivot between said first and second end of each of said first and second support arms adapted for allowing motion of said first and second support arms in a first plane; and
a stabilizing support pivotally attached to said second end of said first support arm adapted to engage said second end of said second support arm when said first and second support arms are pivoted in an open position.

2. The apparatus of claim 1, wherein each of the plurality of cuffs are pivotally attached to said first ends of said first and second support arms.

3. The apparatus of claim 1, further comprising:
gripping means at said second ends of said first and second support arms.

4. The apparatus of claim 1, wherein said cuffs further comprise:
at least one Velcro strap for securing the patient's leg.

5. The apparatus of claim 1, wherein the pivot pivots in multiple planes.

6. The apparatus of claim 1, wherein the cuffs are substantially C shaped.

7. The apparatus of claim 1, wherein the interior of the cuffs are covered by a soft, washable padding.

8. The apparatus of claim 1, wherein the apparatus extends substantially perpendicular to a plane formed by the individual's legs.

9. An apparatus for abducting the legs of a patient, the apparatus comprising:
first and second support arms, each support arm having a first and second end;
first and second cuff supports, each cuff support having a first and second end, and each cuff support attached to the first end of the first and second support arms, respectively;
a plurality of cuffs, at least one cuff at said first and second ends of each of said first and second cuff supports, the cuffs adapted for securing the patient's legs;
a frame for pivotally attaching said second end of said first and second support arms;
a plurality of teeth arranged radially about said second ends of said first and second support arms; and
a screw for engaging said plurality of teeth, said screw being generally positioned tangentially to said plurality of teeth.

10. The apparatus of claim 9, further comprising:
means for turning said screw.

11. The apparatus of claim 9, wherein each of the pair of cuffs is pivotally attached to said first ends of said first and second support arms.

12. The apparatus of claim 9, wherein said cuffs further comprise:
at least one Velcro strap for securing the patient's leg

13. The apparatus of claim 9 wherein the cuffs are substantially C shaped.

14. The apparatus of claim 9, wherein the interior of the cuffs are covered by a soft, washable padding.

15. The apparatus of claim 9, wherein the apparatus extends substantially perpendicular to a plane formed by the individual's legs.

16. A leg abducting apparatus comprising:
a first and second leg holding component, each leg holding component configured to hold a leg of an individual when in use;
a first and second member connected to the first and second component, respectively, and when abducting an individual's legs, the first and second member arranged to extend substantially perpendicular to a plane formed by the individual's legs; and
a device pivotally connecting the first and second members.

17. The apparatus of claim 16, wherein the first and second leg holding component is pivotally attached to said first and second member, respectively.

18. The apparatus of claim 16, wherein said first and second leg holding component further comprise:
at least one Velcro strap for securing the patient's leg

19. The apparatus of claim 16, wherein the first and second leg holding component are substantially C shaped.

20. The apparatus of claim 16, wherein the interior of the first and second leg holding component are covered by a soft, washable padding.
